(19) United States
(12) Patent Application Publication
(10) Pub. No.: US 2003/0110357 A1
(43) Pub. Date: Jun. 12, 2003

(54) Weight based disk cache replacement method

(76) Inventors: Phillip V. Nguyen, San Jose, CA (US); Archana Sathaye, San Jose, CA (US)

Correspondence Address: WAGNER, MURABITO & HAO LLP, Third Floor, Two North Market Street, San Jose, CA, 95113, US

(21) Appl. No.: 10/003,194

(22) Filed: Nov. 14, 2001

(51) Int. Cl. G06F 12/00

(52) U.S. Cl. 711/136

(57) ABSTRACT

A method for replacing disk memory blocks in a cache when a cache miss occurs. A weighting factor is accumulated for each disk memory block which is representative of the number of hits the disk memory block receives. To improve access time, the cache is divided into three buffer segments. The information resides in these buffers based on frequency of access. Upon a cache miss, new data is inserted at the top position of the first buffer, extra data from the bottom of the first buffer is migrated to the top position of the second buffer and extra data from the bottom position of the second buffer is migrated to the top position of the third buffer. The extra data in the third buffer is evicted based on both recentness and frequency of usage. For a cache hit, the weighting factor is augmented and the disk memory block is moved to the top position of the first buffer.

### BACKGROUND OF THE INVENTION

1. Field of the Invention

The present invention relates to the field of cache memory. Specifically, an embodiment of the present invention relates to a weight-based method for replacing blocks of memory in a disk drive cache.

2. Related Art

Emerging Internet related applications, such as multimedia, and traditional applications, such as scientific modeling, place an ever-increasing demand on the disk drive. Over the last several years processor speeds have increased dramatically and the improvements for main memory, in terms of density and access time, have similarly advanced in parallel. However, while the improvements for disk areal density have kept pace, the disk access time has improved only minimally. As a result, the disk access time is a major bottleneck, limiting overall system response time.

The main contributors to delays in disk access time are seek and rotational delays. In general, a cache memory buffer is used to help reduce these delays. Disk drive manufacturers have been shipping disk drives with such a cache installed.

The on-board random access memory (RAM), which is used as a cache, has size ranging from 512 Kbytes to 2 Mbytes. There are various cache management processes stored in the on-board ROM that are executed by the on-board processor to manage such a cache. The cache replacement process is the one that has the most impact on the performance. When the requests can be served from the buffer, a cache hit occurs and access is most efficient, requiring only microseconds to transfer data from the cache. If a request cannot be served from the buffer, cache miss is said to occur and, in addition to data transfer time, the request also incurs disk access time, summing up to a total of milliseconds to transfer the data.

Currently, disk drive vendors employ Least Recently Used (LRU) and First In First Out (FIFO) replacement procedures in managing such a cache buffer. Unfortunately, these replacement procedures do not have the ability to distinguish between frequently referenced disk memory blocks and less frequently referenced disk memory blocks. In other words, these replacement procedures are not able to recognize the host access pattern. The LRU replacement procedure uses only the time since last access and does not take into account the reference frequency of disk memory blocks when making replacement decisions. The FIFO replacement procedure replaces the oldest disk memory blocks since its first reference. It, too, does not take into account the reference frequency of disk memory blocks. These phenomena affect the cache miss ratio negatively.

FIFO replaces or evicts the disk memory blocks that have been resident in the cache the longest time. It treats the cache as a circular buffer, and disk memory blocks are evicted in round-robin style. This is one of the simplest disk memory block replacement procedures to implement. The logic behind this choice, other than its simplicity, is that, disk memory blocks fetched into cache a long time ago may have now fallen out of use. Here, the cache is treated as a queue of disk memory blocks. The oldest disk memory block resides at the HEAD of the queue and the newest disk memory block resides at the END of the queue.

For cache miss, FIFO handles disk memory block access as follows: (1) if there is available space in cache, fetch the requested disk memory block and place it at END of the queue; (2) if there is no available space in cache, evict or replace a disk memory block at HEAD of the queue, then fetch the requested disk memory block and place it at END of the queue. For a cache hit, the hit disk memory block in cache is not touched.

LRU replaces or evicts the disk memory blocks in cache that have not been referenced for the longest time. The logic behind this choice is that, by the principle of locality, disk memory blocks that have not been referenced for the longest time are least likely to be referenced in the near future. This procedure is widely implemented in commercial products, despite its high computational overhead. FIG. 1 shows a layout of a cache using the LRU replacement procedure. Here, the cache is treated as a stack of disk memory blocks. Each rectangular box in the cache represents a disk memory block number. Most recently accessed disk memory block 1 resides at the MRU end of the stack, and least recently accessed disk memory block n resides at the LRU end of the stack.

For cache miss, LRU handles disk memory block access as follows: (1) if there is available space in cache, fetch the disk memory block and place it at MRU of the stack; (2) if there is no available space in cache, evict or replace the disk memory block at LRU of the stack, then fetch the disk memory block and place it at MRU of the stack. For a cache hit, LRU handles disk memory block access as follows: remove the hit disk memory block from the stack and place it at MRU of the stack.

### SUMMARY OF THE INVENTION

A cache replacement method, called a Weight-Based (WB) replacement method, is disclosed. This method resolves the basic deficiency of LRU and FIFO. This WB replacement method makes replacement decisions using a combination of reference frequency and disk memory block age.

For replacing disk memory blocks in a cache when a cache miss occurs, a weighting factor is accumulated for each disk memory. The weighting factor represents the number of hits the disk memory block receives. To improve access time, the cache is divided into three buffer segments. The information resides in these buffers based on frequency of access. Upon a cache miss, new data is inserted at the top position of the first buffer, extra data from the bottom of the first buffer is migrated to the top position of the second buffer and extra data from the bottom position of the second buffer is migrated to the top position of the third buffer. The extra data in the third buffer is evicted based on both recentness and frequency of usage. For a cache hit, the weighting factor is augmented and the disk memory block is moved to the top position of the first buffer.

The WB replacement method, according to one embodiment of the present invention, uses portions of the LRU replacement algorithm. The cache consists of a stack of disk memory blocks with the most recently referenced disk memory block pushed on the top of the stack. However, unlike LRU replacement, the least recently used disk memory block will not be selected for replacement on a cache miss. Instead, a weight count is maintained for each disk memory block in the cache. A disk memory block with high weight count has been accessed or referenced frequently. When replacement is needed, a recently used disk memory block with smallest weight count is selected.

According to one embodiment, the entire cache is divided into three subcaches, called referenced-most-frequently (RMF) subcache, referenced-relatively-frequently (RRF) subcache, and referenced-least-frequently (RLF) subcache. The size of the individual subcaches can vary, but the sum of the sizes of the three subcaches equals the size of the entire cache.

Each subcache is treated as a small cache that has an MRU end and an LRU end. Disk memory blocks in each subcache are ordered from the most to the least recently accessed or referenced. The reason for dividing the entire cache into three subcaches is to allow ready assignment of different levels of access frequency to each subcache.

The RMF subcache is used to store the disk memory blocks that are referenced most frequently. The RRF subcache is used to store the disk memory blocks, which are referenced relatively frequently. The RLF subcache is used to store the disk memory blocks, which are referenced least frequently. For example, cache miss disk memory blocks are first brought into the RMF subcache. If they are accessed again soon, they continue to remain in RMF subcache. The newly accessed disk memory blocks are brought into the MRU end of the RMF subcache and the previously current disk memory blocks are pushed toward the LRU end of the RMF subcache and, eventually, into the RRF subcache.

The current disk memory blocks in the RRF subcache are given a second chance before being subject to replacement. If they are not accessed again soon, they will be pushed down in the cache toward the LRU end and, eventually, into the RLF subcache. The disk memory blocks in the RLF subcache are available for replacement. Therefore disk memory blocks that are accessed most frequently or relatively frequently will be protected from replacement. The replacement decisions are confined to disk memory blocks in the RLF subcache. When replacement is necessary, a recently used disk memory block with the smallest weight count is selected.

Data blocks of the RMF are moved from the bottom end to the top end of the RRF when no space remains in the RMF. Likewise, disk memory blocks of the RRF are moved from the bottom end to the top end of the RLF when no space remains in the RRF. When the RLF is full, disk memory blocks are evicted from the cache based on usage and weight information.

Regarding weight assignments, on a cache hit, a weight count associated with the disk memory block is increased provided the weight count has not reached a predetermined maximum value. On a cache hit, the disk memory block is also moved to the top of the RMF. When evicting from the RLF, the eviction process traverses from the bottom of the RLF and selects a disk memory block that has a low weight and was not used very recently.

During each weight-based replacement process a check is made to see if weight count adjustment is appropriate. This is to prevent a frequently accessed disk memory block from accumulating a weight count so high that it would continue to occupy space in the cache long after it ceased to be referenced. The average weight count of all disk memory blocks within the cache is determined and compared to a predetermined maximum value. If the predetermined maximum value is exceeded, the disk memory block weight counts are all halved.

### BRIEF DESCRIPTION OF THE DRAWINGS

FIG. 1 is a block diagram of a least-recently-used (LRU) method of cache replacement according to the prior art.

FIG. 2 illustrates a logical diagram of a disk drive with an exemplary embedded computer system upon which an embodiment of the present invention may be practiced.

FIG. 3 is a block diagram of a cache layout using weight-based replacement methodology according to an embodiment of the present invention.

FIG. 4 is a block diagram of subcaches according to an embodiment of the present invention.

FIG. 5 is a flow diagram of steps for handling block overflow and placing a disk memory block into a subcache according to an embodiment of the present invention.

FIG. 6 is a flow diagram of steps for evicting a disk memory block according to an embodiment of the present invention.

FIGS. 7A and 7B are flow diagrams of steps for scanning the subcaches for a disk memory block in accordance with an embodiment of the present invention.

FIG. 8 is a flow diagram of steps for checking and adjusting weight counts of all disk memory blocks in accordance with an embodiment of the present invention.

FIGS. 9A, 9B and 9C are flow diagrams illustrating the process of weight-based replacement for write-through and write-back caches.

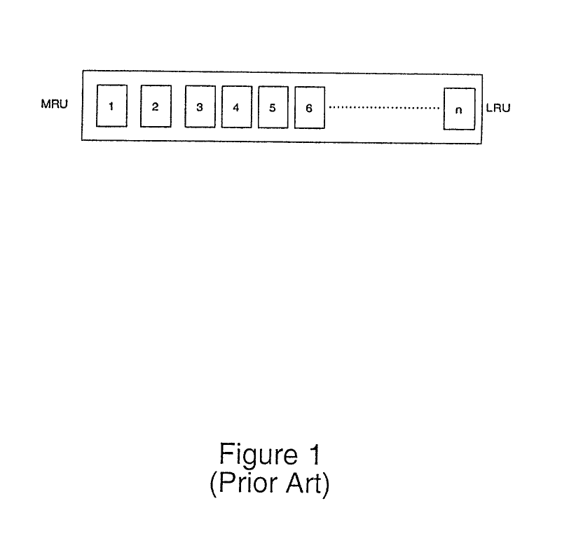

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Notation and Nomenclature

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic information capable of being stored, transferred, combined, compared, and otherwise manipulated in a computer system. It has proven convenient at times, principally for reasons of common usage, to refer to these information as transactions, bits, values, elements, symbols, characters, fragments, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “analyzing,” “determining,” “using,” “extracting,” “accumulating”, “migrating”, evicting” or the like, refer to actions and processes of a computer system or similar electronic computing device. The computer system or similar electronic computing device manipulates and transforms data represented as physical (electronic) quantities within the computer system memories, registers or other such information storage, transmission or display devices. The present invention is well suited to the use of other computer systems.

Exemplary Computer System

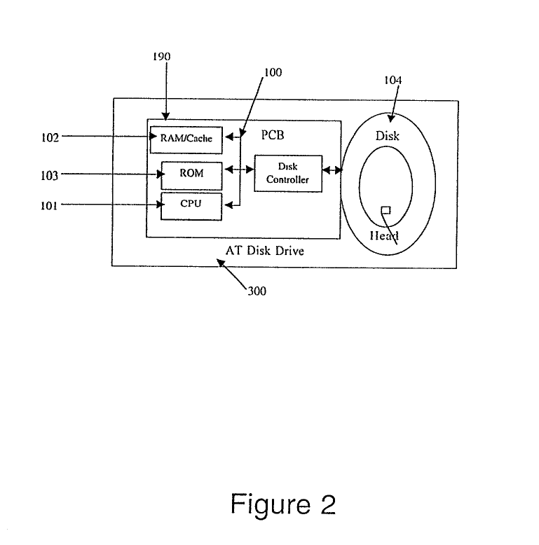

Refer now to FIG. 2 that illustrates an ANSI bus interface protocol (AT) disk drive 300 with an on-board exemplary embedded computer system 190 upon which embodiments of the present invention may be practiced. In general, embedded computer system 190 comprises bus 100 for communicating information, processor 101 coupled with bus 100 for processing information and instructions, and random access (volatile) memory (RAM)/Cache 102 coupled with bus 100 for storing information and instructions for processor 101.

The RAM/cache 102 of FIG. 2 has size ranging from 512 Kbytes to 2 Mbytes. There are various cache management methods stored in the on-board read-only memory (ROM) 103 which are executed by the on-board central processing unit (CPU) 101 to manage the RAM/Cache 102. The cache replacement method has a significant impact on the performance of the RAM/Cache 102. One such cache replacement method is the WB replacement method of one embodiment of the present invention. Embedded computer system 190 also comprises a data storage device 104 such as a magnetic or optical disk and disk drive coupled with bus 100 for storing information and instructions.

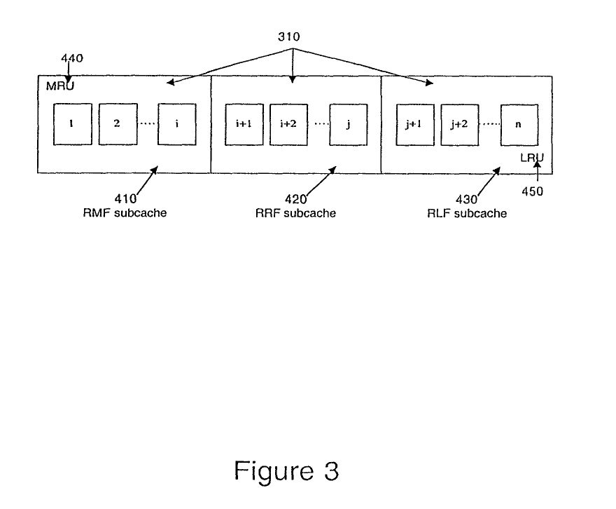

FIG. 3 illustrates a cache 310 of disk memory blocks partitioned into three subcaches according to one embodiment of the present invention. Subcache 410 is the subcache containing disk memory blocks that are referenced most frequently. Subcache 420 contains the disk memory blocks that are referenced relatively frequently. The disk memory blocks contained in subcache 430 are those referenced least frequently.

The size of each subcache is a fraction of the size of the entire cache. That is, the sum of the size of each subcache must equal the size of the entire cache. If the size of the entire cache is S, and the size of each subcache is S_{RMF}, S_{RRF}, and S_{RLF}, respectively, the size of each subcache can be set to any size, such that S=S_{RMF}+S_{RRF}+S_{RLF}. For example, if S=512, then, according to one embodiment, S_{RMF},=256 (½ of S), S_{RRF}=128 (¼ of S), and S_{RLF}=128 (¼ of S). S_{RMF}, S_{RRF}, and S_{RLF} are parameters that can be set to affect the cache performance. In FIG. 3, MRU 440 is the most recently used top of the stack and LRU 450 is the least recently used bottom of the stack. Most recently referenced disk memory block 1 resides at the top of the stack and least recently referenced disk memory block n resides at the bottom of the stack.

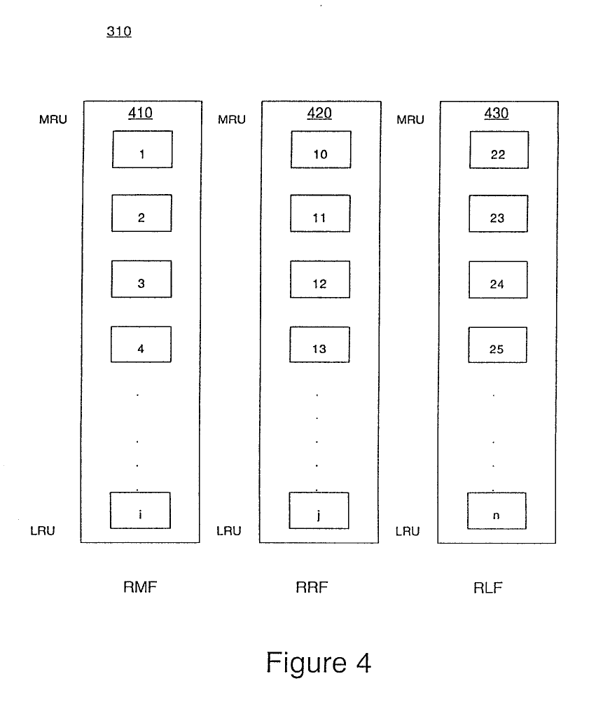

Referring now to FIG. 4, the cache is shown completely partitioned into three separate subcaches 410, 420 and 430 according to one embodiment of the present invention. Each subcache is treated as a small cache that has an MRU end and an LRU end. Disk memory blocks in each subcache are ordered from the most to the least recently accessed or referenced. The reason for dividing the entire cache into three subcaches is to allow easy assignment of different levels of access frequency to each subcache. The RMF subcache 410 is used to store the disk memory blocks that are referenced most frequently. The RRF subcache 420 is used to store the disk memory blocks that are referenced relatively frequently. The RLF subcache 430 is used to store the disk memory blocks that are referenced least frequently.

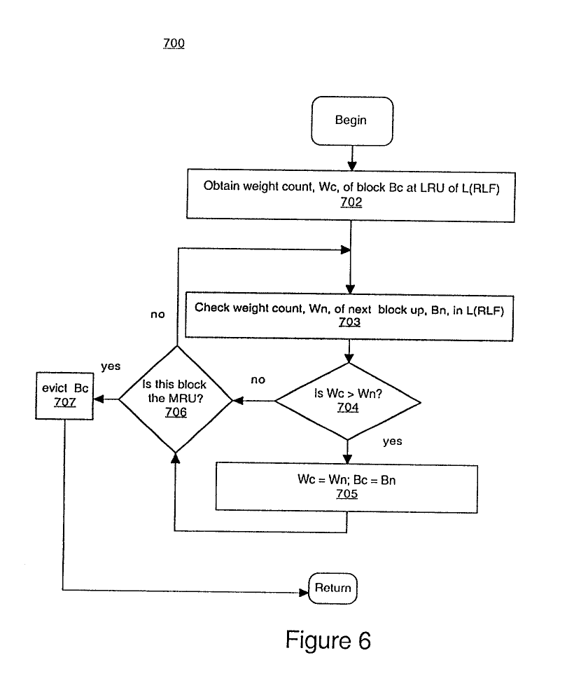

Still referring to FIG. 4, on a cache miss, a disk memory block is fetched, assigned a weight count of one, and space within the cache is allocated in accordance with one embodiment. If there is space available in RMF subcache 410, then this disk memory block is placed at the MRU end of this subcache. If there is no space available in RMF subcache 410, then this disk memory block is placed at the MRU end of this subcache 410 and the disk memory block at the LRU end of RMF subcache 410 is pushed onto the MRU end of RRF subcache 420. If RRF subcache 420 is full, the disk memory block at the LRU end of this subcache 420 is pushed onto the MRU end of RLF subcache 430. If RLF subcache 430 is full, a disk memory block with a combination of smallest weight count and least recent access is evicted. Refer to FIG. 6 for details of the determination of the combination of smallest weight count and least recent access.

On a cache hit, according to one embodiment of the present invention, if a disk memory block hits in RMF subcache 410 of FIG. 4, its weight count is not incremented, and it is placed at the MRU end of this subcache 410. If a disk memory block hits in RRF subcache 420 or RLF subcache 430, its weight count is incremented by one and it is placed at the MRU end of RMF subcache 410. If RMF subcache 410 is full, the disk memory block at the LRU end of it is pushed onto the MRU end of RRF subcache 420. If RRF subcache 420 is full, the disk memory block at the LRU end of RRF subcache 420 is pushed onto the MRU end of RLF subcache 430.

Still referring to FIG. 4, in accordance with one embodiment of the present invention, if a cache hit occurs on disk memory blocks in RMF subcache 410, the disk memory block weight counts are not incremented. This is to prevent disk memory blocks from building up high weight counts due to repeatedly being re-referenced for short intervals of time due to locality. At the end of an interval of time during which the disk memory blocks are being frequently re-referenced, if the weight counts were to be accumulated, the high weight count that they accumulate would be misleading and therefore cannot be used to estimate the probability that such a block will be re-referenced following the end of this interval.

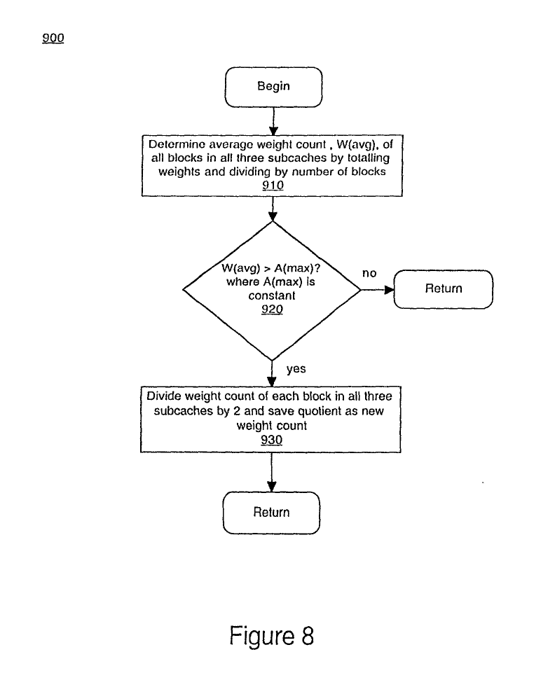

However, certain disk memory blocks may build up high weight counts and never be replaced. These disk memory blocks become fixed in the cache. These disk memory blocks should either stay fixed in the cache if they are among the most frequently referenced disk memory blocks, or they should not stay fixed in the cache if they are no longer being referenced and the spaces they occupy in the cache are wasted. In such a case, these disk memory blocks that have high weight counts and are no longer being referenced should be evicted to make space for the future incoming disk memory blocks. The method for handling these high-weight disk memory blocks is discussed with FIG. 8.

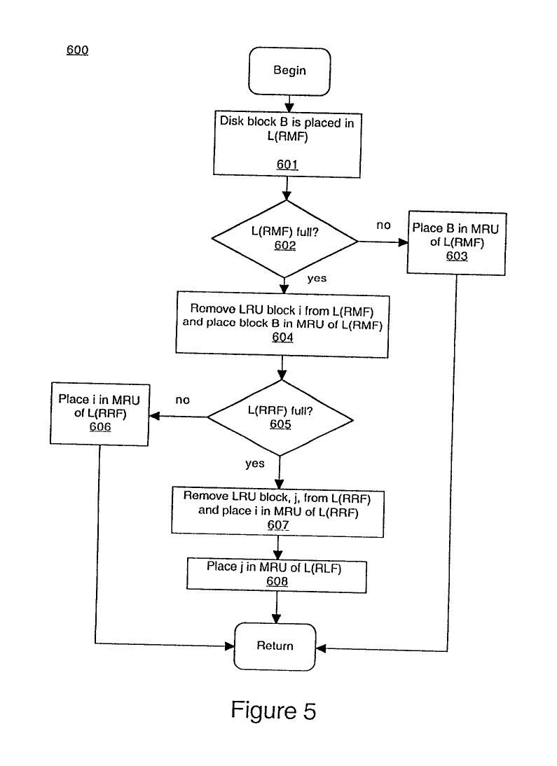

Referring now to FIG. 5, the steps for handling block overflow and placing a disk memory block into a subcache according to one embodiment of the present invention is presented in flow diagram 600. In step 601 disk memory block B is placed in L(RMF) and in step 602. L(RMF), the most frequently referenced subcache, is examined for space availability. If there is space available, per step 603, disk memory block B is placed at the most recently used (MRU) end of L(RMF). If L(RMF) is full, the least recently used (LRU) disk memory block i is removed from L(RMF) per step 604, disk memory block B is placed at the most recently used (MRU) end of L(RMF).

Still referring to FIG. 5, in step 605, the relatively frequently referenced subcache, L(RRF) is next checked for space availability. If there is space available, as shown in step 606, disk memory block i is placed at the most recently used (MRU) end of L(RRF). If L(RRF) is full, the least recently used (LRU) disk memory block j is removed from L(RRF) in step 607, and disk memory block i is placed at the most recently used (MRU) end of L(RRF). In step 608, disk memory bock j is placed at MRU end of L(RLF).

Table I below, a method for handling block overflow and placing disk block into L_{RMF}, illustrates one example of a pseudo code that could be used for implementing the method of FIG. 5:

TABLE I

begin

B := disk block to place into L_{RMF}
R, T := invalid_disk_block
if (L_{RMF} is full) {handle L_{RMF} full}

begin

R := remove a LRU disk bock from L_{RMF}
place B at the MRU of L_{RMF}
if (L_{RRF} is full)

begin

T := remove a LRU disk block form L_{RRF}
place R at MRU of L_{RRF}
place T at MRU of L_{RLF}

end

else

begin

place R at MRU of L_{RRF}

end

end

else {handle L_{RMF} not full}

begin

place B at MRU of L_{RMF}

end

end

FIG. 6 is a flow diagram 700 illustrating the steps for evicting a disk memory block according to one embodiment of the present invention. In this embodiment, the least frequently referenced subcache, L(RLF), is searched for a recently used disk memory block with the smallest weight count. Beginning with the LRU end of L(RLF) subcache, the weight count, Wc, of the disk memory block Bc is obtained as shown in step 702. In step 703, the weight count, Wn, of the next disk memory block Bn up in L(RLF) subcache is obtained and compared in step 704 to Wc.

Continuing with FIG. 6, in the present embodiment, in step 704, if Wc is greater than Wn, then Wc is set equal to Wn and Bc is set equal to Bn, as shown in step 705. The disk memory block for which Wn is the weight count is tested in step 706 to see if it is the most recently used (MRU) block in subcache L(RLF). If so, then the MRU end of L(RLF) has been reached and disk block Bc, which is least recently used with smallest weight count, is evicted. If not, then the weight count Wn of the next block Bn up in the L(RLF) subcache is checked as shown in step 703 and compared to the previous weight count, Wc, and the process is continued until either a smaller weight count is encountered or the MRU disk memory block position is reached.

Table II below, a method for evicting a LRU disk block with smallest weight count in L_{RLF}, illustrates one example of a pseudo code that could be used for implementing the method of FIG. 6:

TABLE II

begin

start from the LRU of L_{RLF}
W_{c} := get weight counts of a disk block B_{c} at LRU of L_{RLF}
while (not end of L_{RLF})

begin

Wₙ := get weight counts of a next disk block Bₙ in L_{RLF}
if (W_{c} > Wₙ)

begin

W_{c} := Wₙ
B_{c}:= Bₙ

end

end

evict B_{c}

end

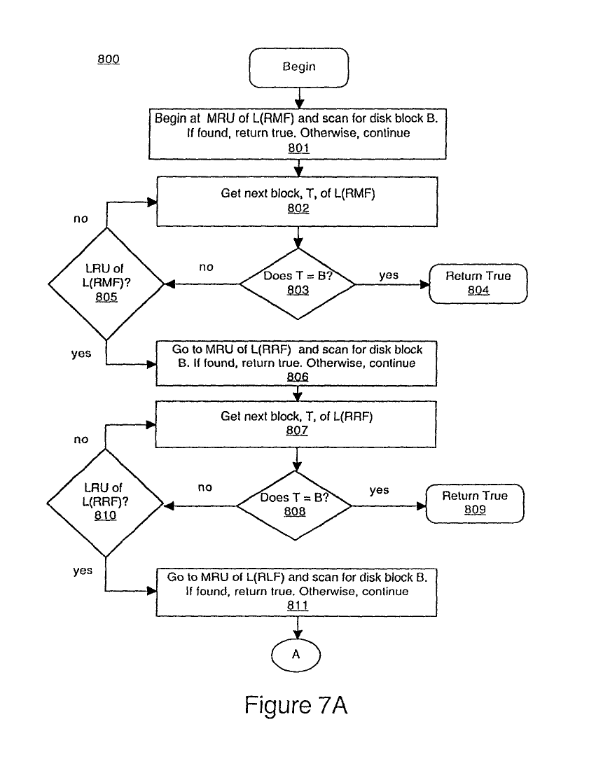

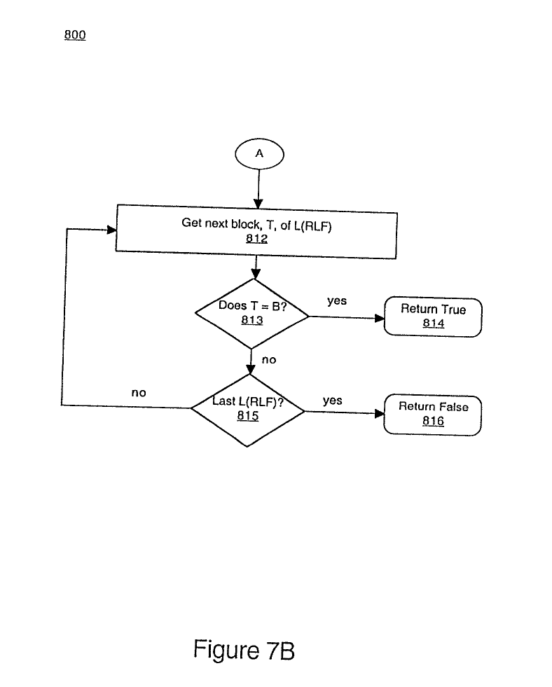

Referring now to FIGS. 7A and 7B, flow diagrams of the steps for scanning the subcaches for a disk memory block, in accordance with one embodiment of the present invention, are presented. In this process, L(RMF) subcache is scanned first, beginning with the MRU end of the subcache. In the present embodiment the disk memory block to be scanned is disk memory block B, as illustrated in step 801 of FIG. 7A. If found, true is returned and the block is located. If not, the next block down in L(RMF) subcache, T, is scanned as illustrated in step 802. This block is examined and, in step 803, if T is equal to B, the requested block, then true is returned as shown in step 804 and the requested block is located. If not, in step 805 the process tests to see if the LRU end of the L(RMF) subcache has been reached. If the LRU end of L(RMF) has not been reached, the search continues down the L(RMF) subcache until B is located, or until the LRU end of L(RMF) is reached.

Continuing with FIG. 7A, if the LRU end of L(RMF) subcache is encountered prior to locating the disk memory block B for which the scan is being performed, the L(RRF) subcache is entered, beginning with the MRU end of the subcache as illustrated in step 806. If found, true is returned and the block is located. If not, the next block down in L(RRF) subcache, T, is scanned as illustrated in step 807. This block is examined and, in step 808, if T is equal to B, the requested block, then true is returned as shown in step 809 and the requested block is located. If not, in step 810 the process tests to see if the LRU end of the L(RRF) subcache has been reached. If the LRU end of the L(RRF) subcache has not been reached, the search continues down the L(RRF) subcache until B is located, or until the LRU end of L(RRF) is reached. If the LRU end of L(RRF) subcache is encountered prior to locating the disk memory block B for which the scan is being performed, the L(RLF) subcache is entered, beginning with the MRU end of the subcache as illustrated in step 811. If the requested disk memory block B is found, true is returned and the block is located.

Referring now to FIG. 7B, if the disk memory block B has not been found, the next block down in L(RLF) subcache, T, is scanned as illustrated in step 812. This block is examined and, in step 813, if T is equal to B, the requested block, then true is returned as shown in step 814 and the requested block is located. If not, the process tests in step 815 to see if the LRU end of the L(RLF) subcache has been reached. If not, the search continues down the L(RRF) subcache until B is located, or until the LRU end of L(RRF) is reached. If the LRU end of the L(RLF) subcache is encountered and the disk memory block

B is not located, false is returned as illustrated in step 816 and a cache miss has occurred.

Table III below, a method for scanning L_{RMF}, L_{RRF}, and L_{RLF} for a disk block, illustrates one example of a pseudo code that could be used for implementing the method of FIGS. 7A and 7B:

TABLE III

begin

B := disk block to scan in L_{RMF}, L_{RRF}, and L_{RLF}
start from MRU of L_{RMF}
while (not end of L_{RMF})

begin

T := get a next disk block in L_{RMF}
if (B = T)

begin

return True

end

end

start from MRU of L_{RRF}
while (not end of L_{RRF})

begin

T := get a next disk block in L_{RRF}
if (B = T)

begin

return True

end

end

start from MRU of L_{RLF}
while (not end of L_{RLF})

begin

T := get a next disk block in L_{RLF}
if (B = T)

begin

return True

end

end

return False

end

Referring to FIG. 8, an approach of periodic aging by division is used to adjust the weight count of each disk memory block according to one embodiment of the present invention. This is done in such a way that, if a disk memory block is no longer referenced, its weight count will be reduced to a smaller weight count. Eventually the disk memory block's weight count becomes minimal and, thus, qualifies for eviction. The periodic aging by division is illustrated by flow diagram in FIG. 8.

In step 910 of FIG. 8, the average weight count, W(avg), of all disk memory blocks in all three subcaches is determined by first totaling the weight counts, beginning at the MRU end of L(RMF) subcache and continuing to the LRU end of L(RLF) subcache. The sum is then divided by the total number of disk memory blocks to arrive at W(avg). In step 920, according to the present embodiment, W(avg) is compared to a predetermined constant, A(max). A(max) is a flag to indicate that the average value of the weight counts is becoming too great and should be reduced.

Still referring to FIG. 8, if W(avg) is less than or equal to A(max), no action is required. If W(avg) is greater than A(max), the weight count of each disk memory block in all three subcaches, beginning with the LRU end of L(RMF) subcache and continuing to the LRU end of L(RLF) subcache, is divided by two. The quotient is then saved as the weight count for each disk memory block as illustrated by step 930.

Table IV below, a method for checking and adjusting weight counts of all disk blocks, illustrates one example of a pseudo code that could be used for implementing the method of FIG. 8:

```
TABLE IV
begin
  start from MRU of L_{RMF}
  while (not end of L_{RMF})
```

begin

Wₛ := Wₛ + weight counts of a next disk block in L_{RMF}
Bₜ := Bₜ + 1

end

```
  start from MRU of L_{RRF}
  while (not end of L_{RRF})
```

begin

Wₛ := Wₛ + weight counts of a next disk block in L_{RRF}
Bₜ := Bₜ + 1

end

```
  start from MRU of L_{RLF}
  while (not end of L_{RLF})
```

begin

Wₛ := Wₛ + weight counts of a next disk block in L_{RLF}
Bₜ := Bₜ + 1

end

```
  W_{avg} := Wₛ / Bₜ {keep W_{avg} as integer}
  if (W_{avg} > Aₘₐₓ) {Aₘₐₓ is an integer}
```

begin

start from MRU of L_{RMF}
while (not end of L_{RMF})

begin

get a next disk block in L_{RMF}
save (weight counts of this disk block / 2) as new weight
counts for this disk block

end

start from MRU of L_{RRF}
while (not end of L_{RRF})

begin

get a next disk block from L_{RRF}
save (weight counts of this disk block / 2) as new weight
counts for this disk block

end

start from MRU of L_{RLF}
while (not end of L_{RLF})

begin

get a next disk block from L_{RLF}
save (weight counts of this disk block / 2) as new weight
counts for disk block

end

end

end

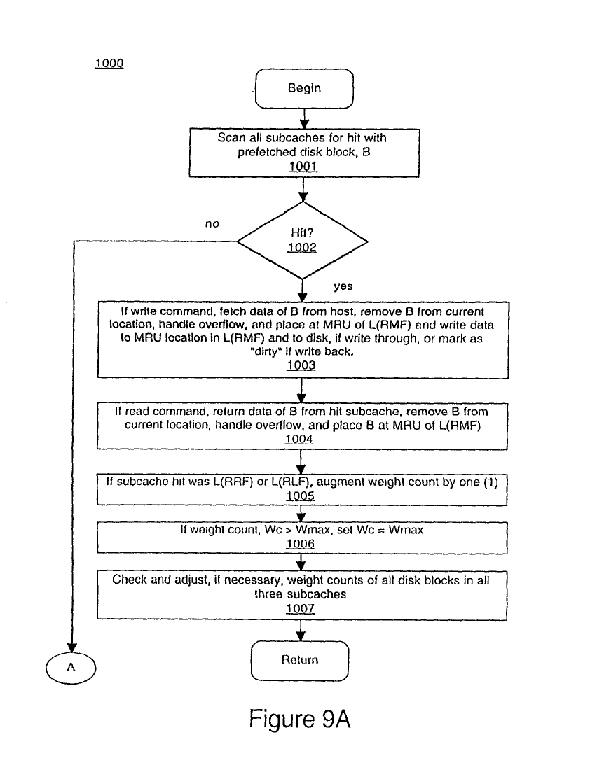

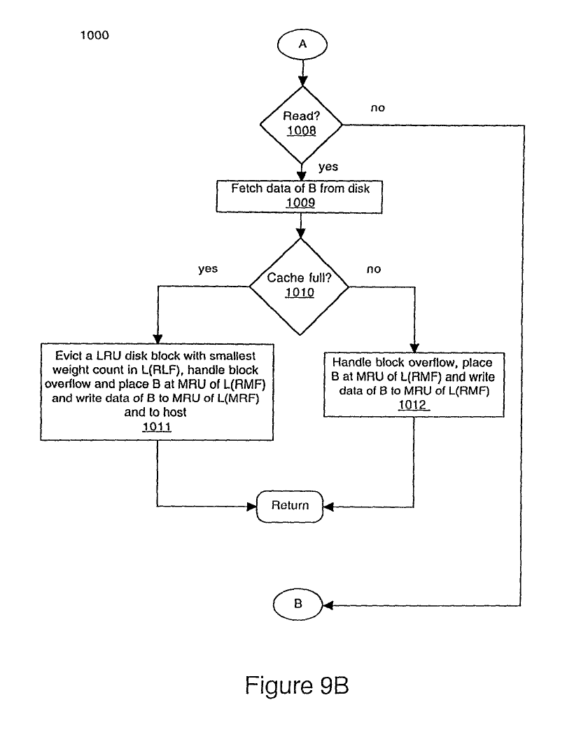

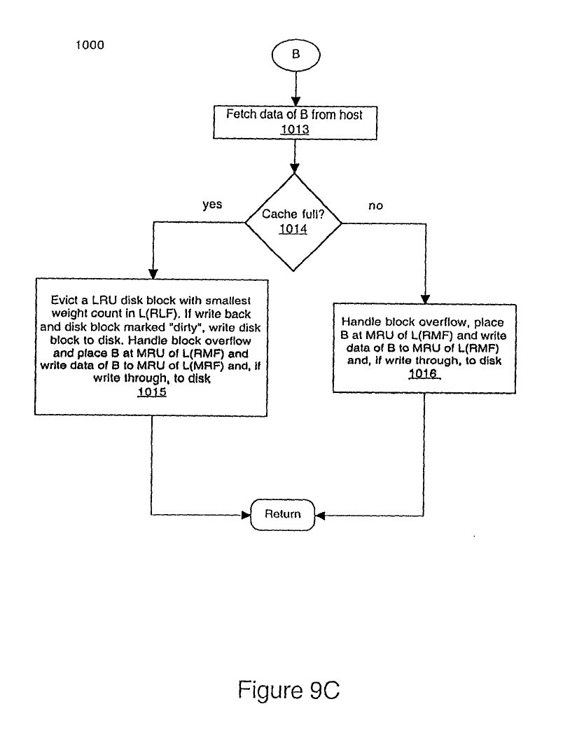

Referring now to FIGS. 9A, 9B and 9C, flow diagrams are presented which illustrate the process of weight-based replacement for write-through and write-back caches. Beginning with FIG. 9A, in step 1001 the subcaches are scanned for disk memory block B. If block B is found in the cache, a cache hit, as indicated in step 1002, occurs and this information is simply returned to the host immediately for further command.

In step 1003 of FIG. 9A, if a cache hit occurs and there is a write command, the data of disk memory block B is fetched from the host, B is removed from its current location, overflow is handled, and B is placed at the MRU position in subcache L(RMF) and the data of disk memory block B is written in the MRU position of L(RMF). For a write-through cache, the data is also written to disk at this time. For a write-back cache, the B disk memory block data is marked as “dirty” and will be written to disk at such time as it is evicted from the cache.

Still referring to FIG. 9A, if a cache hit occurs and there is a read command, the data of disk memory block B is returned from the hit subcache, as shown in step 1004. B is then removed from its current location, overflow is handled, and B is placed in the MRU position of subcache L(RMF).

If B hits in L(RRF) or L(RLF), its weight count (Wc) is incremented by 1 as illustrated by step 1005, and Wc is then compared to a predetermined constant, W(max). If Wc is greater than W(max), Wc is then set equal to W(max) as shown in step 1006 of FIG. 9A. This prevents a disk memory block that is frequently referenced for a short time interval from building up such a large weight count that it would remain resident in the cache long after it was no longer being referenced.

Next, referring now to step 1007 of FIG. 9A, the weight counts are averaged and compared to the constant, Amax. If necessary, the weight counts are adjusted according to the steps of FIG. 8.

FIG. 9B is a continuation of the process of weight-based replacement for write-through and write-back caches. In FIG. 9B, a cache miss has occurred for disk memory block B and there is a read command as illustrated with step 1008. In step 1009, the data of disk memory block B is fetched from its location in disk memory. In step 1010, the cache is checked for available space, beginning with L(RMF) subcache and proceeding through subcache L(RRF) and subcache L(RLF) until an available space is located or until it is determined that the cache is full. In step 1012, an available space is located, disk memory block B is placed at the MRU position of subcache L(RMF), overflow is handled, and its data is written to the MRU position of subcache L(RMF) and to the host.

Step 1011 of FIG. 9B illustrates a cache miss when the cache is full and a read command is present. In this instance, a least frequently used disk memory block in subcache L(RLF) with the lowest weight count is evicted, overflow is handled, B is placed at the MRU position of subcache L(RMF), and the data of disk memory block is written to MRU of subcache L(RMF) and to the host. If the cache is a write-back cache, the data is written to the disk provided the disk memory block is marked “dirty”.

Referring now to FIG. 9C, a cache miss has occurred for disk memory block B and there is a write command. The data of B is fetched from the host as illustrated in step 1013. In step 1014, the cache is checked for available space, beginning with L(RMF) subcache and proceeding through subcache L(RRF) and subcache L(RLF) until an available space is located or until it is determined that the cache is full. If an available space is located, disk memory block B is placed at the MRU position of subcache L(RMF), overflow is handled and its data is written to the MRU position of subcache L(RMF) and, if write-through, to the disk.

Step 1015 of FIG. 9C illustrates a cache miss when the cache is full and a write command is present. In this instance, a least frequently used disk memory block in subcache L(RLF) with the lowest weight count is evicted, overflow is handled, B is placed at the MRU position of subcache L(RMF), and the data of disk memory block is written to MRU of subcache L(RMF) and, if write-through, to the disk. If the cache is a write-back cache, the data is written to the disk if the disk memory block is marked “dirty”.

Table V below, a WB Replacement Method using Write-Through Cache, illustrates one example of a pseudo code that could be used for implementing the method of FIGS. 9A, 9B and 9C for a write-through cache:

```
TABLE V
begin
  Bᵢ := initial disk block i host requested; Nb := number of disk blocks host
  requested
  Cmd := current command opcode; Ref := Ref + Nb; Cache_hit := False
  Cache_full := False
  while (Nb != 0)
```

begin

Cache_hit := scan L_{RMF}, L_{RRF}, and L_{RLF} for Bᵢ
if (Cache_hit) {handle cache hit}

begin

if (Cmd = Write) {handle write command}

begin

fetch data of Bᵢ from host; Miss := Miss + 1
remove Bᵢ from current location in hit subcache
handle block overflow and place Bᵢ at MRU of L_{RMF}
write data of Bᵢ to MRU location in L_{RMF} and to disk

end

else if (Cmd = Read) {handle read command}

begin

return data of Bᵢ to host from hit subcache
remove Bᵢ from current location in hit subcache
handle block overflow and place Bᵢ at MRU of L_{RMF}

end

if (Cache_hit in L_{RRF} or L_{RLF})

begin

if (Wᵢ < Wₘₐₓ) Wᵢ := Wᵢ + 1

end

end

else {handle cache miss}

begin

Miss := Miss + 1; Wᵢ := 1
if (Cmd = Read) {handle read command}

begin

fetch data of Bᵢ from disk
if (not (Cache_full := check for space available for Bᵢ in L_{RMF}, L_{RRF},

L_{RLF})) {handle cache not full}

begin

handle block overflow and place Bᵢ at MRU of L_{RMF}
write data of Bᵢ to MRU location in L_{RMF} and to host

end

else {handle cache full}

begin

evict a LRU disk block with smallest weight counts in L_{RLF}
handle block overflow and place Bᵢ at MRU of L_{RMF}
write data of Bᵢ to MRU location in L_{RMF} and to host

end

end

else if (Cmd = Write) {handle write command}

begin

fetch data of Bᵢ from host
if (not (Cache_full := check for space available for Bᵢ in L_{RMF}, L_{RRF},

L_{RLF})) {handle cache not full}

begin

handle block overflow and place Bᵢ at MRU of L_{RMF}
write data of Bᵢ to MRU location in L_{RMF} and to disk

end

else {handle cache full}

begin

evict a LRU disk block with smallest weight count in L_{RLF}
handle block overflow and place Bᵢ at MRU of L_{RMF}
write data of Bᵢ to MRU location in L_{RMF} and to disk

end

end

end
Nb := Nb − 1; i := i + 1
check and adjust weight counts of all disk blocks in L_{RMF}, L_{RRF}, L_{RLF}

end
prefetch sequential disk blocks starting from Bᵢ for P disk blocks

end

Table VI below, a method for checking space available in L_{RMF}, L_{RRF}, and L_{RLF}, illustrates one example of a pseudo code for checking space available in the three subcaches:

TABLE VI

begin

start from MRU of L_{RMF}
i := 0
while (not end of L_{RMF})

begin

i := i + 1

end

if (i < S_{RMF})

begin

return False

end

start from MRU of L_{RRF}
i := 0
while (not end of L_{RRF})

begin

i := i + 1

end

if (i < S_{RRF})

begin

return False

end

start from MRU of L_{RLF}
i := i + 0
while (not end of L_{RLF})

begin

i := i + 1

end

if (i < S_{RLF})

begin

return False

end

return True

end

Table VII below, a WB Replacement Method using Write-Back Cache, illustrates one example of a pseudo code that could be used for implementing the method of FIGS. 9A, 9B and 9C for a write-back cache:

```
TABLE VII
begin
  Bᵢ := initial disk block i host requested; Nb := number of disk blocks host
  requested
  Cmd := current command opoode; Ref := Ref + Nb; Cache_hit := False
  Cache_full := False; Dᵢ := False {dirty flag for disk block Bᵢ}
  while (Nb != 0)
```

begin

Cache_hit := scan L_{RMF}, L_{RRF}, and L_{RLF} for Bᵢ
if (Cache_hit) {handle cache hit}

begin

if (Cmd = Write) {handle write command}

begin

fetch data of Bᵢ from host; Dᵢ := True
remove Bᵢ from current location in hit subcache
handle block overflow and place Bᵢ at MRU of L_{RMF}
write data of Bᵢ to MRU location in L_{RMF}

end

else if (Cmd = Read) {handle read command}

begin

return data of Bᵢ to host from hit subcache
remove Bᵢ from current location in hit subcache
handle block overflow and place Bᵢ at MRU of L_{RMF}

end

if (Cache_hit in L_{RRF} or L_{RLF})

begin

if (Wᵢ < Wₘₐₓ) Wᵢ := Wᵢ + 1

end

end

else {handle cache miss}

begin

if (Cmd = Read) {handle read command}

begin

fetch data of Bᵢ from disk; Miss := Miss + 1; Wᵢ := 1
if (not (Cache_full := check for space available for Bᵢ in L_{RMF}, L_{RRF},

L_{RLF})) {handle cache not full}

begin

handle block overflow and place Bᵢ at MRU of L_{RMF}
write data of Bᵢ to MRU location in L_{RMF} and to host

end

else {handle cache full}

begin

evict a LRU disk block with smallest weight counts in L_{RLF}
if (evicted disk block dirty)

begin

write evicted disk block to disk; Miss := Miss + 1

end
handle block overflow and place Bᵢ at MRU of L_{RMF}
write data of Bᵢ to MRU location in L_{RMF} and to host

end

end

else if (Cmd = Write) {handle write command}

begin

fetch data of Bᵢ from host; Dᵢ := True; Wᵢ := 1
if (not (Cache_full := check for space available for Bᵢ in L_{RMF}, L_{RRF},

L_{RLF})) {handle cache not full}

begin

handle block overflow and place Bᵢ at MRU of L_{RMF}
write data of Bᵢ to MRU location in L_{RMF}

end

else {handle cache full}

begin

evict a LRU disk block with smallest weight count in L_{RLF}
if (evicted disk block dirty)
begin

write evicted disk block to disk; Miss := Miss + 1

end
handle block overflow and place Bᵢ at MRU of L_{RMF}
write data of Bᵢ to MRU location in L_{RMF}

end

end

end
Nb := Nb − 1, i := i + 1
check and adjust weight counts of all disk blocks in L_{RMF}, L_{RRF}, L_{RLF}

end
prefetch sequential disk blocks starting from Bᵢ for P disk blocks

end

Accordingly, what is presented is a method for storing a large percentage of frequently referenced disk memory blocks in the cache so as to reduce the number of cache misses and, therefore, the excess time required for disk access.

The preferred embodiment of the present invention, a weight based replacement method for replacing disk memory blocks for cache hits in a disk drive cache, is thus described. While the present invention has been described in particular embodiments, it should be appreciated that the present invention should not be construed as limited by such embodiments, but rather construed according to the below claims.

What is claimed is:

1. A cache system comprising:
a first buffer for receiving new data at a top buffer position and for storing most recently referenced data ordered by usage;
a second buffer for storing relatively recently referenced data ordered by usage and for receiving extra data from a bottom buffer position of said first buffer; and
a third buffer for storing least recently referenced data ordered by usage and for receiving extra data from a bottom buffer position of said second buffer, wherein each data of said first, second and third buffer contain an associated weight and wherein data are evicted from said third buffer based on both weight and usage.

2. A cache system as described in claim 1 wherein, upon a cache miss:
a) new data is inserted into said first buffer at said top buffer position;
b) extra data from said first buffer is inserted into a top buffer position of said second buffer; and
c) extra data from said second buffer is inserted into a top buffer position of said third buffer.

3. A cache system as described in claim 2 wherein, upon said cache miss:
d) extra data from said third buffer is subject to eviction, wherein further, a least recently referenced data with lowest weight is selected for said eviction.

4. A cache system as described in claim 1 wherein, upon a cache hit of a hit data:
a) a weight value associated with said hit data is incremented; and
b) said hit data and its associated weight value are moved and inserted into said top buffer position of said first buffer.

5. A cache system as described in claim 4 wherein, upon said cache hit of said hit data:
c) extra data from said first buffer is inserted into a top buffer position of said second buffer; and
d) extra data from said second buffer is inserted into a top buffer position of said third buffer.

6. A cache system as described in claim 1 wherein each weight value of data of said first, second and third buffers are halved upon an event.

7. A cache system as described in claim 6 wherein said event is defined by an average weight value of said data of said first, second and third buffers exceeding a predetermined threshold.

8. A cache system as described in claim 1 wherein data is evicted from said third buffer by:
a) traversing data from a bottom buffer position upward until the top buffer position is reached or until a weight value associated with a next data is equal to or greater than a weight value associated with a current data; and
b) evicting said current data.

9. In a disk drive comprising a first subcache, a second subcache and a third subcache, said first subcache comprising a first most-recently-used location, a method for caching comprising:
a) assigning weight counts to disk memory blocks;
b) augmenting said weight counts for occurrences of cache hits on disk memory blocks residing in said second and said third subcaches;
c) reducing said weight counts when an average weight count of all said weight counts exceeds a predetermined maximum value; and
d) evicting a disk memory block with lowest weight count and least recent use from said third subcache when said cache is full and a cache miss occurs.

10. The method of claim 9 wherein a currently accessed disk memory block is placed in said first most-recently-used location in said first subcache.

11. The method of claim 9 further comprising migrating disk memory blocks from said first subcache to said second subcache in response to an overflow in said first subcache.

12. The method of claim 9 further comprising migrating disk memory blocks from said second subcache to said third subcache in response to an overflow in said second subcache.

13. The method of claim 9 wherein said second subcache comprises a second most-recently-used location and a second least-recently-used location.

14. The method of claim 13 wherein said first subcache comprises a first least-recently-used location which contains a first disk memory block, said first disk memory block being more recently used than a second disk memory block, said second disk memory block comprised in said second most-recently-used location of said second subcache.

15. The method of claim 9 wherein said third subcache comprises a third most-recently-used location and a third least-recently-used location.

16. The method of claim 15 wherein said second least-recently-used location of said second subcache contains a third disk memory block, said third disk memory block being more recently used than a fourth disk memory block, said fourth disk memory block comprised in said third most-recently-used location of said third subcache.

17. The method of claim 9 wherein said reducing said weight count when said average weight count of all said weight counts exceeds said predetermined value comprises dividing all said weight counts by two.

18. In a disk drive comprising a cache comprising a first subcache, a second subcache and a third subcache, said first subcache comprising a first most-recently-used location, a method for replacing disk memory blocks in said cache, said method comprising:
a) placing a currently accessed disk memory block in said first most-recently-used location in said first subcache;
b) migrating disk memory blocks from said first subcache to said second subcache in response to an overflow in said first subcache; and
c) migrating disk memory blocks from said second subcache to said third subcache in response to an overflow in said second subcache.

19. The method of claim 18 further comprising assigning a weight count to said disk memory blocks.

20. The method of claim 19 further comprising augmenting said weight count for a cache hit on one of said disk memory blocks residing in said second or said third subcache.

21. The method of claim 19 further comprising reducing weight count by half when the average weight count of all said weight counts exceeds a predetermined threshold.

22. The method of claim 18 further comprising evicting a disk memory block residing in said third subcache and having a lowest weight count and least recent use upon a cache miss, provided all locations of said cache are filled.

23. The method of claim 18 wherein said second subcache comprises a second most-recently-used location and a second least-recently-used location.

24. The method of claim 23 wherein said first subcache comprises a first least-recently-used location which contains a first disk memory block, said first disk memory block being more recently used than a second disk memory block, said second disk memory block comprised in said second most-recently-used location of said second subcache.

25. The method of claim 18 wherein said third subcache comprises a third most-recently-used location and a third least-recently-used location.

26. The method of claim 25 wherein said second least-recently-used location of said second subcache contains a third disk memory block, said third disk memory block being more recently used than a fourth disk memory block, said fourth disk memory block comprised in said third most-recently-used location of said third subcache.

27. A disk drive comprising a cache having a first subcache, a second subcache and a third subcache, said first subcache comprising a first most-recently-used location and a computer-usable medium comprising computer-readable program code embodied therein that implement a method for replacing disk memory blocks in said disk drive cache, said method comprising:
a) assigning weight counts to disk memory blocks;
b) augmenting said weight counts for occurrences of cache hits on disk memory blocks residing in said second and said third subcaches;
c) reducing said weight counts when an average weight count of all said weight counts exceeds a predetermined maximum value; and
d) evicting a disk memory block with lowest weight count and least recent use from said third subcache when said cache is full and a cache miss occurs.

28. The disk drive of claim 27 wherein a currently accessed disk memory block is placed in said first most-recently-used location in said first subcache.

29. The disk drive of claim 27 wherein said method further comprises migrating disk memory blocks from said first subcache to said second subcache in response to overflow in said first subcache.

30. The disk drive of claim 27 wherein said method further comprises migrating disk memory blocks from said second subcache to said third subcache in response to an overflow in said second subcache.

31. The disk drive of claim 27 wherein said second subcache comprises a second most-recently-used location and a second least-recently-used location.

32. The disk drive of claim 31 wherein said first subcache comprises a first least-recently-used location which contains a first disk memory block, said first disk memory block being more recently used than a second disk memory block, said second disk memory block comprised in said second most-recently-used location of said second subcache.

33. The disk drive of claim 27 wherein said third subcache comprises a third most-recently-used location and a third least-recently-used location.

34. The disk drive of claim 33 wherein said second least-recently-used location of said second subcache contains a third disk memory block, said third disk memory block being more recently used than a fourth disk memory block, said fourth disk memory block comprised in said third most-recently-used location of said third subcache.

35. The disk drive of claim 27 wherein said reducing said weight count when said average weight count of all said weight counts exceeds said predetermined value comprises dividing all said weight counts by two.
